(19) United States
(12) Patent Application Publication
(10) Pub. No.: US 2026/0032334 A1
(43) Pub. Date: Jan. 29, 2026

(54) INFORMATION PROCESSING APPARATUS, CONTROL METHOD OF INFORMATION PROCESSING APPARATUS, RECORDING MEDIUM, AND SYSTEM

(71) Applicant: CANON KABUSHIKI KAISHA, Tokyo (JP)

(72) Inventor: YUSUKE CHIHARA, Chiba (JP)

(21) Appl. No.: 19/251,594

(22) Filed: Jun. 26, 2025

(30) Foreign Application Priority Data
Jul. 24, 2024 (JP) 2024-119166

(51) Int. Cl. H04N 23/63; G06F 3/14

(52) U.S. Cl. CPC H04N 23/632; G06F 3/14

(57) ABSTRACT

According to an aspect of the present disclosure, an information processing apparatus includes a processor and a memory storing a program which, when executed by the processor, causes the information processing apparatus to execute determination processing to determine a first display method to be used in displaying a live-view image on a display unit by causing a user to perform selection from among a plurality of display methods including a distortion-reduce display method, and execute control processing to perform control to display the live-view image on the display unit by the first display method, and in a case where an imaging instruction is issued while the live-view image is displayed on the display unit by first display method, control to display a captured image recorded in a recording unit on the display unit based on the imaging instruction by the first display method.

### BACKGROUND

### Field of the Technology

The present disclosure relates to an information processing apparatus, a control method for controlling the same, a program, a recording medium, and a system and more particularly to display control of virtual reality (VR) content.

### Description of the Related Art

A technology for displaying a stereoscopic virtual reality (VR) image by acquiring wide field-of-view angle images having a parallax by using two optical systems and mapping the images onto virtual spheres has become widespread. A double-lens VR camera for capturing the VR image includes two optical systems directed in the same direction, and can capture two images having a parallax by a single imaging operation. Some double-lens VR cameras can capture an image of a range as wide as or wider than 180° in vertical and lateral directions (hemisphere, 90° in all directions from the image center) with each optical system.

Examples of display methods used in displaying a VR image include “non-VR display” where a left-eye image and a right-eye image acquired by the respective optical systems of the double-lens VR camera are displayed as simply arranged side by side, and “VR display” where the left- and right-eye images are mapped on virtual spheres and displayed as a stereoscopic video image.

The display methods may be able to specify which range of the entire image to display. There have been described techniques for switching such a plurality of display methods depending on various conditions such as the user's operations and functions implemented in the device.

For example, Japanese Patent Laid-Open No. 2019-012881 describes a technique that normally displays either a first image that is an image of a predetermined range of a VR image or a second image with a range narrower than the range of the first image. When imaging preparation instructions are issued by the user, the display is controlled to be switched to the other of the first and second images or both.

For example, WO 2017/145721 discuses a technique for outputting displayable image data to an information processing apparatus based on information processing apparatus information including information about whether the information processing apparatus has a VR image display function and VR identification information including information about whether the image data includes a VR image.

According to the conventional technique described in WO 2017/145721, the display method of a live-view image while capturing a VR image and the display method during playback of the captured image recorded in a recording unit to check the imaging result afterward are not necessarily the same. For example, suppose that VR display is selected as the display method of the live-view image during imaging, and non-VR display is selected as the display method during playback of the recorded image after imaging. In such a case, the photographer visually observes the object in a VR image until immediately before imaging, but the captured recorded image is not displayed as a VR image. In other words, the photographer is unable to immediately check the object in the captured recorded image by VR display even though the object has been visually observed by VR display until immediately before the imaging. To switch the display methods involves additional operations for issuing instructions.

### SUMMARY

The present disclosure is directed to providing an information processing apparatus that presents a recorded captured image by using a method corresponding to the display method of a live-view image while capturing a virtual reality (VR) image.

According to an aspect of the present disclosure, an information processing apparatus includes a processor; and a memory storing a program which, when executed by the processor, causes the information processing apparatus to execute determination processing to determine a display method to be used in displaying a live-view image on a display unit by causing a user to perform selection from among a plurality of display methods including a distortion-reduce display method, and execute control processing to perform control to display the live-view image on the display unit, and in a case where an imaging instruction is issued while the live-view image is displayed on the display unit, control to display a captured image recorded in a recording unit on the display unit based on the imaging instruction, wherein in a case where a first display method is selected by the user, the live-view image and the captured image are displayed on the display unit by using the first display method, and in a case where a second display method is selected by the user, the live-view image and the captured image are displayed on the display unit by using the second display method.

Features of the present disclosure will become apparent from the following description of embodiments with reference to the attached drawings. The following description of embodiments is described by way of example.

### BRIEF DESCRIPTION OF THE DRAWINGS

FIG. 1A is a diagram illustrating an example of an external configuration of the front of a camera according to one or more aspects of the present disclosure. FIG. 1B is a diagram illustrating an example of an external configuration of the rear of the camera according to one or more aspects of the present disclosure.

FIG. 2 is a diagram illustrating an example of an internal configuration of the camera according to one or more aspects of the present disclosure.

FIG. 3 is a schematic diagram illustrating an example of a configuration of a lens unit according to one or more aspects of the present disclosure.

FIG. 4 is a diagram illustrating transitions of a virtual reality (VR) image display method during imaging and during playback according to one or more aspects of the present disclosure.

FIG. 5 is a flowchart of imaging processing of the camera according to one or more aspects of the present disclosure.

FIG. 6 is a flowchart of playback processing of the camera according to one or more aspects of the present disclosure.

FIG. 7 is a flowchart of display method switch processing of the camera according to one or more aspects of the present disclosure.

### DESCRIPTION OF THE EMBODIMENTS

The embodiments will be described in detail below with reference to the accompanying drawings. It should be noted that the following embodiments do not limit the disclosure related to the scope of the claims. Although multiple features are described in the embodiments, not all of these features are essential to the disclosure, and the features may be combined arbitrarily. Furthermore, in the accompanying drawings, the same or similar components are denoted by the same reference numerals, and redundant descriptions are omitted.

### First Embodiment

Desirable embodiments of the present disclosure will be described in detail below with reference to the attached drawings. A first embodiment will be described by using a case where an information processing apparatus (display apparatus) is a digital camera as an example.

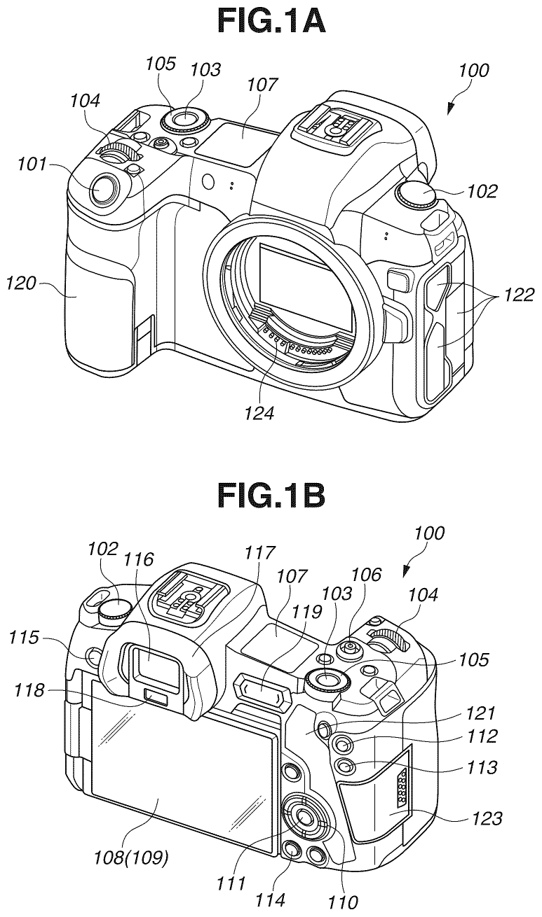

FIGS. 1A and 1B are diagrams illustrating an example of an external configuration of a digital camera 100 (hereinafter, camera 100). FIG. 1A is a front perspective view of the camera 100. FIG. 1B is a rear perspective view of the camera 100.

The camera 100 includes a shutter button 101, a power switch 102, a mode change switch 103, a main electronic dial 104, a sub electronic dial 105, a moving image button 106, and an extra-viewfinder display unit 107 on its top surface. The shutter button 101 is an operation unit for issuing imaging preparation or imaging instructions. The power switch 102 is an operation unit for switching the power of the camera 100 on and off. The mode change switch 103 is an operation unit for switching various modes. The main electronic dial 104 is a rotary operation unit for changing setting values such as a shutter speed and aperture. The sub electronic dial 105 is a rotary operation unit for moving a selection frame (cursor) and fast-forwarding images. The moving image button 106 is an operation unit for issuing instructions to start and stop capturing (recording) a moving image. The extra-viewfinder display unit 107 displays various setting values such as the shutter speed and aperture.

The camera 100 also includes a display unit 108, a touchscreen 109, a directional keypad 110, a set button 111, an automatic exposure (AE) lock button 112, a magnify button 113, a playback button 114, a menu button 115, an eyepiece unit 116, an eye detection unit 118, and a touch bar 119. The display unit 108 displays images and various types of information. The touchscreen 109 is an operation unit that detects touch operations on the display surface (touch operation surface) of the display unit 108. The directional keypad 110 is an operation unit including keys (four-way keys) that can be pressed in up, down, left, and right directions. Operations can be performed based on the pressed position of the directional keypad 110. The set button 111 is an operation unit that is mainly pressed in determining a selection item. The AE lock button 112 is an operation unit to be pressed in locking an exposure state in an imaging standby state. The magnify button 113 is an operation unit for switching a magnification mode on and off during live-view (LV) display in an imaging mode. When the magnification mode is on, operating the main electronic dial 104 magnifies or reduces the LV image. As employed herein, LV refers to a function of displaying a video image on an image sensor upon an electronic viewfinder (EVF) or monitor. The LV image refers to the image displayed during the use of this function. The magnify button 113 is also used to magnify a playback image or increase the magnification in a playback mode. The playback button 114 is an operation unit for switching between the imaging mode and the playback mode. When the playback button 114 is pressed in the imaging mode, the camera 100 enters the playback mode, whereby the latest image among images recorded on a recording medium 227 to be described below can be displayed on the display unit 108.

The menu button 115 is an operation unit to be pressed in displaying a menu screen capable of configuring various settings on the display unit 108. The user can intuitively configure various settings using the menu screen displayed on the display unit 108, the directional keypad 110, and the set button 111. The eyepiece unit 116 is a part for the user to put an eye on an eyepiece viewfinder (look-into viewfinder) 117. The user can visually observe the video image displayed on the EVF 217 to be described below inside via the eyepiece unit 116. The eye detection unit 118 is a sensor that detects whether the user is putting their eye on the eyepiece unit 116.

The touch bar 119 is a line-shaped touch operation unit (line touch sensor) capable of accepting touch operations. The touch bar 119 is located at a position where the user can make touch operations (can touch) with the right thumb when gripping a grip portion 120 with the right hand (with the right little finger, ring finger, and middle finger) so that the shutter button 101 can be pressed with the right index finger.

In other words, the touch bar 119 can be operated in a state (imaging posture) where the user puts their eye on the eyepiece unit 116, looks into the eyepiece viewfinder 117, and holds the camera 100 so that the shutter button 101 can be pressed any time. The touch bar 119 can accept a tap operation (operation of making a touch and releasing the touch within a predetermined period without move) on the touch bar 119, as well as slide operations to the left and right (operations of making a touch and moving the touch position without releasing the touch). The touch bar 119 is an operation unit different from the touchscreen 109 and does not have a display function. The touch bar 119 according to the present embodiment is a multifunction bar and functions as a multifunction (M-Fn) bar, for example.

The camera 100 also includes the grip portion 120, a thumb rest portion 121, terminal covers 122, a lid 123, and a communication terminal 124. The grip portion 120 is a holding portion formed in a shape easy to grip by the right hand when the user holds the camera 100 in position. The shutter button 101 and the main electronic dial 104 are disposed at positions operable by the right index finger in a state where the camera 100 is held with the grip portion 120 gripped with the right little finger, ring finger, and middle fingers. The sub electronic dial 105 and the touch bar 119 are located at positions operable by the right thumb in a similar state. The thumb rest portion 121 (thumb standby position) is a grip portion disposed on the rear of the camera 100, at a position where the thumb of the right hand gripping the grip portion 120 is easy to place without any operation unit being operated. The thumb rest portion 121 is made of a rubber member for enhanced gripping force (gripping feel). The terminal covers 122 protect connectors of connection cables for connecting the camera 100 to external devices. The lid 123 closes off a slot for accommodating the recording medium 227 to be described below, whereby the recording medium 227 and the slot are protected. The communication terminal 124 is a terminal for communicating with a lens unit 200 to be described below, which is detachably attachable to the camera 100.

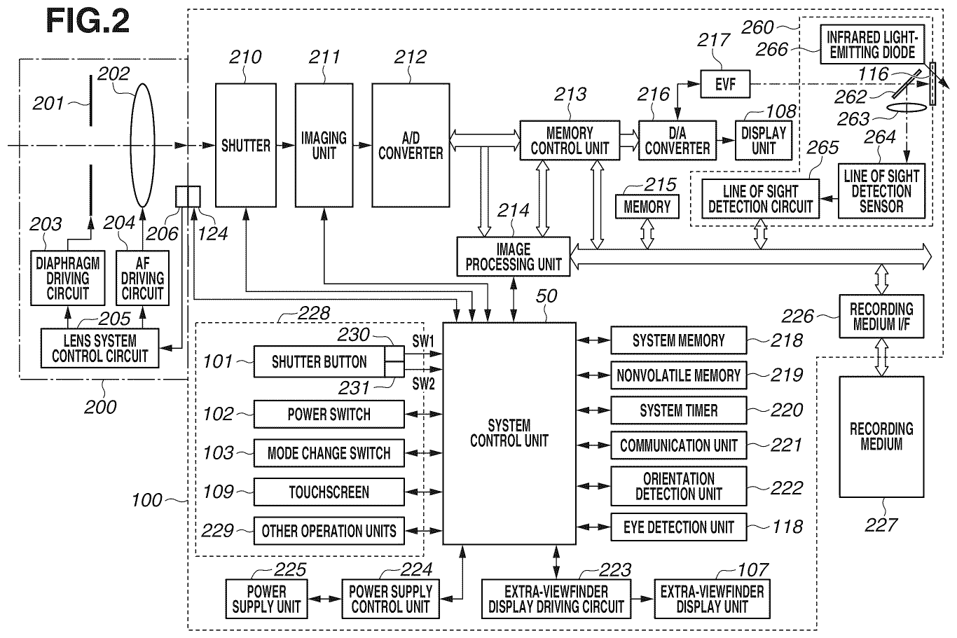

FIG. 2 is a diagram illustrating an example of an internal configuration of the camera 100. Components similar to those of FIGS. 1A and 1B are denoted by the same reference numerals, and a description thereof will be omitted as appropriate. The lens unit 200 is mounted on the camera 100.

The lens unit 200 will initially be described. The lens unit 200 is a type of interchangeable lens detachably attachable to the camera 100. The lens unit 200 is a single-lens unit and is an example of a normal lens.

The lens unit 200 includes a diaphragm 201, a lens 202, a diaphragm driving circuit 203, an autofocus (AF) driving circuit 204, a lens system control circuit 205, and a communication terminal 206.

The diaphragm 201 is configured so that its aperture diameter can be adjusted. The lens 202 includes a plurality of lenses. The diaphragm driving circuit 203 adjustments the amount of light by controlling the aperture diameter of the diaphragm 201. The AF driving circuit 204 drives the lens 202 for focusing. The lens system control circuit 205 controls the diaphragm driving circuit 203 and the AF driving circuit 204 based on instructions from a system control unit 50 to be described below. The lens system control circuit 205 controls the diaphragm 201 via the diaphragm driving circuit 203 and changes the position of the lens 202 via the AF driving circuit 204 for focusing. The lens system control circuit 205 can communicate with the camera 100. Specifically, the lens system control circuit 205 communicates with the camera 100 via the communication terminal 206 of the lens unit 200 and the communication terminal 124 of the camera 100. The communication terminal 206 is a terminal for the lens unit 200 to communicate with the camera 100.

Next, the camera 100 will be described. The camera 100 includes a shutter 210, an imaging unit 211, an analog-to-digital (A/D) converter 212, a memory control unit 213, an image processing unit 214, a memory 215, a digital-to-analog (D/A) converter 216, the EVF 217, the display unit 108, and the system control unit 50.

The shutter 210 is a focal plane shutter that can freely control the exposure time of the imaging unit 211 based on instructions from the system control unit 50. The imaging unit 211 is an image sensor including charge-coupled device (CCD) or complementary metal-oxide-semiconductor (CMOS) elements for converting an optical image into an electrical signal. The imaging unit 211 may include an image plane phase-difference sensor that outputs defocus amount information to the system control unit 50. The A/D converter 212 converts an analog signal output from the imaging unit 211 into a digital signal. The image processing unit 214 performs predetermined processing (such as pixel interpolation, reduction and other resize processing, and color conversion processing) on data from the A/D converter 212 or data from the memory control unit 213. The image processing unit 214 also performs predetermined calculation processing using captured image data, and the system control unit 50 performs exposure control and ranging control based on the obtained calculation result. Through such processing, through-the-lens (TTL) AF processing, AE processing, and electronic flash (EF) (preliminary flash emission) processing are performed. The image processing unit 214 further performs predetermined calculation processing using the captured image data, and performs TTL automatic white balance (AWB) processing based on the obtained calculation result.

Image data from the A/D converter 212 is written to the memory 215 via the image processing unit 214 and the memory control unit 213. Alternatively, the image data from the A/D converter 212 is written to the memory 215 via the memory control unit 213 without the intermediary of the image processing unit 214. The memory 215 stores the image data that is obtained by the imaging unit 211 and digitally converted by the A/D converter 212, and image data to be displayed on the display unit 108 and the EVF 217. The memory 215 has a storage capacity sufficient to store a predetermined number of still images and a predetermined duration of moving image and sound. The memory 215 also serves as an image display memory (video memory).

The D/A converter 216 converts data for image display (image data for display) stored in the memory 215 into an analog signal and supplies the analog signal to the display unit 108 and the EVF 217. The image data for display written to the memory 215 is thus displayed as an LV image on the display unit 108 and the EVF 217 via the D/A converter 216. The display unit 108 and the EVF 217 provide display based on the analog signal from the D/A converter 216. Examples of the display unit 108 and the EVF 217 include a liquid crystal display (LCD) and an organic electroluminescence (EL) display. LV display is provided by converting the digital signal that is A/D-converted by the A/D converter 212 and stored in the memory 215 into an analog signal by the D/A converter 216 and successively transferring the analog signal to the display unit 108 and the EVF 217 for display.

The system control unit 50 is a control unit including at least one processor and/or at least one circuit. In other words, the system control unit 50 may be a processor, a circuit, or a combination of a processor and a circuit. The system control unit 50 controls entire operation of the camera 100. The system control unit 50 implements the processing of flowcharts to be described below by executing programs recorded in a nonvolatile memory 219. The system control unit 50 also performs display control by controlling the memory 215, the D/A converter 216, the display unit 108, and the EVF 217.

The camera 100 also includes a system memory 218, the nonvolatile memory 219, a system timer 220, a communication unit 221, an orientation detection unit 222, and the eye detection unit 118.

The system memory 218 is a random access memory (RAM), for example. Operation constants of the system control unit 50, variables, and programs read from the nonvolatile memory 219 are loaded into the system memory 218. The nonvolatile memory 219 is an electrically erasable and recordable memory. For example, an electrically erasable programmable read-only memory (EEPROM) is used as the nonvolatile memory 219. The operation constants of the system control unit 50 and the programs are recorded in the nonvolatile memory 219. As employed herein, the programs refer to ones for performing flowcharts to be described below. The system timer 220 is a clocking unit that measures time for use in various types of control and the time of a built-in clock. The communication unit 221 transmits and receives video signals and audio signals to/from external equipment connected wirelessly or by a cable. The communication unit 221 can also connect to a wireless local area network (LAN) and the Internet. The communication unit 221 can also communicate with external equipment via Bluetooth® or Bluetooth® Low Energy. The communication unit 221 can transmit images (including a live image) captured by the imaging unit 211 and the images recorded on the recording medium 227, and can receive image data and other various types of information from external equipment. The orientation detection unit 222 detects the orientation of the camera 100 with respect to the direction of gravity. Whether an image captured by the imaging unit 211 is one captured with the camera 100 held landscape or one captured with the camera 100 held portrait can be determined based on the orientation detected by the orientation detection unit 222. The system control unit 50 can add orientation information corresponding to the orientation detected by the orientation detection unit 222 to the image file of the image captured by the imaging unit 211, or rotate and record the image. For example, an acceleration sensor or gyro sensor can be used for the orientation detection unit 222. The movement (such as pan, tilt, lift-up, and whether stationary or not) of the camera 100 can also be detected using the orientation detection unit 222.

The eye detection unit 118 can detect the approach of an object to the eyepiece unit 116 of the eyepiece viewfinder 117 where the EVF 217 is built in. For example, an infrared proximity sensor can be used for the eye detection unit 118. When an object approaches, infrared rays emitted from a light projection part of the eye detection unit 118 are reflected at the object and received by a light receiving part of the infrared proximity sensor. The distance from the eyepiece unit 116 to the object can be determined based on the amount of infrared rays received. In such a manner, the eye detection unit 118 performs eye detection for detecting the approaching distance of the object to the eyepiece unit 116. The eye detection unit 118 is an eye detection sensor for detecting the approach (eye contact) and withdrawal (eye separation) of an eye (object) to/from the eyepiece unit 116 of the eyepiece viewfinder 117. In a case where an object approaching from a non-contact state (non-approaching state) to within a predetermined distance from the eyepiece unit 116 is detected, eye contact is detected. By contrast, in a case where an object of which approach has been detected gets separated from the eye contact state (approaching state) to a predetermined distance or more, eye separation is detected. The threshold for detecting eye contact and the threshold for detecting eye separation may differ with a hysteresis, for example. After eye contact is detected, the eye contact state continues until eye separation is detected. After eye separation is detected, the eye separation state continues until eye contact is detected. The system control unit 50 switches display (display state) and non-display (non-display state) of the display unit 108 and the EVF 217 based on the state detected by the eye detection unit 118. Specifically, suppose that the camera 100 is at least in an imaging standby state and a display destination switch setting is set to automatic switching. In such a case, during non-eye contact, the system control unit 50 turns on the display of the display unit 108 as the display destination, and turns off the display of the EVF 217. During eye contact, the system control unit 50 turns on the display of the EVF 217 as the display destination, and turns off the display of the display unit 108. The eye detection unit 118 is not limited to an infrared proximity sensor, and other sensors that can detect a state considered to be eye contact may be used.

The camera 100 also includes the extra-viewfinder display unit 107, an extra-viewfinder display driving circuit 223, a power supply control unit 224, a power supply unit 225, a recording medium interface (I/F) 226, and an operation unit 228.

The extra-viewfinder display unit 107 displays various setting values of the camera 100, such as the shutter speed and aperture, via the extra-viewfinder display driving circuit 223. The power supply control unit 224 includes a battery detection circuit, a direct-current-to-direct-current (DC-DC) converter, and a switch circuit for switching blocks to be energized, and detects the presence or absence of a battery attached, the type of battery, and the remaining battery level. The power supply control unit 224 controls the DC-DC converter based on the detection results and instructions from the system control unit 50, and supplies various components, including the recording medium 227, with predetermined voltages for predetermined periods. The power supply unit 225 includes a primary battery such as an alkali battery and a lithium battery, a secondary battery such as a nickel-cadmium (NiCd) battery, a nickel-metal halide (NiMH) battery, and a lithium-ion (Li) battery, and/or an alternating-current (AC) adaptor. The recording medium I/F 226 is an I/F with the recording medium 227 such as a memory card and a hard disk. The recording medium 227 is a memory card or the like for recording captured images, and includes a semiconductor memory or a magnetic disk. The recording medium 227 may be removable or built-in.

The operation unit 228 is an input unit for accepting the user's operation (user operation), and used to input various instructions to the system control unit 50. The operation unit 228 includes the shutter button 101, the power switch 102, the mode change switch 103, the touchscreen 109, and other operation units 229. The other operation units 229 include the main electronic dial 104, the sub electronic dial 105, and the moving image button 106. The other operation units 229 also include the directional keypad 110, the set button 111, the AE lock button 112, the magnify button 113, the playback button 114, the menu button 115, and the touch bar 119.

The shutter button 101 includes a first shutter switch 230 and a second shutter switch 231. The first shutter switch 230 turns on when the shutter button 101 is operated halfway, i.e., half-pressed (imaging preparation instruction), and generates a first shutter switch signal SW1. In response to the first shutter switch signal SW1, the system control unit 50 starts imaging preparation processing such as the AF processing, AE processing, AWB processing, and EF processing. The second shutter switch 231 turns on when the shutter button 101 is fully operated, i.e., fully pressed (imaging instruction), and generates a second shutter switch signal SW2. In response to the second shutter switch signal SW2, the system control unit 50 starts a series of imaging processes from the reading of signals from the imaging unit 211 to the generation of an image file including the captured image and the writing of the image file to the recording medium 227.

The mode change switch 103 switches the operation mode of the system control unit 50 to any one of still image capturing modes, a moving image capturing mode, and the playback mode. The still image capturing modes include an automatic imaging mode, an automatic scene determination mode, a manual mode, an aperture priority mode (aperture value [Av] mode), a shutter speed priority mode (time value [Tv] mode), and a program AE mode (program [P] mode). Various scene modes that are imaging scene-specific imaging settings, and a custom mode are also included. The user can directly switch to one of the foregoing imaging modes using the mode change switch 103. Alternatively, the user can once switch to an imaging mode list screen using the mode change switch 103, and then selectively switch to one of a plurality of modes displayed using the operation unit 228. Similarly, the moving image capturing mode may include a plurality of modes.

The touchscreen 109 is a touch sensor that detects various touch operations on the display surface of the display unit 108 (operation surface of the touchscreen 109). The touchscreen 109 and the display unit 108 can be integrally configured. For example, the touchscreen 109 is attached to the top layer of the display surface of the display unit 108 so that its light transmittance does not interfere with the display on the display unit 108. The input coordinates of the touchscreen 109 and the display coordinates on the display surface of the display unit 108 are then associated with each other, whereby a graphical user interface (GUI) as if the user can directly operate the screen displayed on the display unit 108 can be configured. The touchscreen 109 can use any of various methods including resistive, capacitive, surface acoustic wave, infrared, electromagnetic induction, image recognition, and optical sensor methods.

There are detection methods that detect a touch from a contact on the touchscreen 109 and ones that detect a touch from the approach of a finger or pen to the touchscreen 109. Any of such methods may be employed.

The system control unit 50 can detect the following operations or states of the touchscreen 109:
a finger or pen not touching the touchscreen 109 newly touches the touchscreen 109, which is in other words, a start of a touch (hereinafter, referred to as a touch-down),
the touchscreen 109 is touched with a finger or pen (hereinafter, referred to as a touch-on),
a finger or pen touching the touchscreen 109 moves (hereinafter, referred to as a touch-move),
a finger or pen touching the touchscreen 109 is separated (released) from the touchscreen 109. In other words, an end of a touch (hereinafter, referred to as a touch-up), and
a state where nothing touches the touchscreen 109 (hereinafter, referred to as a touch-off).

When a touch-down is detected, a touch-on is detected at the same time. After a touch-down, a touch-on usually continues to be detected unless a touch-up is detected. When a touch-move is detected, a touch-on is also simultaneously detected. In a case where a touch-on is detected and the touch position does not move, a touch-move is not detected. After a touch-up of all fingers and pens having touched is detected, a touch-off occurs.

Such operations and states and the position coordinates of the fingers and pens touching the touchscreen 109 are notified to the system control unit 50 via an internal bus. The system control unit 50 determines what operation (touch operation) has been performed on the touchscreen 109 based on the notified information. For a touch-move, the moving direction of the finger or pen moving on the touchscreen 109 can be determined in terms of vertical and horizontal components on the touchscreen 109 separately, based on a change in the position coordinates. In a case where a touch-move is detected over a predetermined distance or more, the system control unit 50 determines that a slide operation has been performed made. An operation of quickly moving a finger touching the touchscreen 109 for some distance and immediately releasing the finger is referred to as a flick. In other words, a flick is an operation of quickly sweeping the touchscreen 109 as if flicking with a finger. The system control unit 50 determines that a flick has been performed in a case where a touch-move over a predetermined distance or more at a predetermined speed or more is detected and a touch-up has been immediately detected (it can be determined that a flick has been performed subsequent to a slide operation). A touch operation of simultaneously touching a plurality of points (for example, two points) (making a multi-touch) and bringing the touch positions close to each other is referred to as a pinch-in. A touch operation of moving the touch positions apart from each other is referred to as a pinch-out. A pinch-out and a pinch-in are referred to collectively as a pinch operation (or simply a pinch).

A line of sight detection block 260 is a block for detecting whether the user making eye contact on the eyepiece unit 116 is viewing the EVF 217, and in a case where the user is viewing the EVF 217, the line of sight as to which position the user is looking at.

The line of sight detection block 260 includes a dichroic mirror 262, an imaging lens 263, a line of sight detection sensor 264, a line of sight detection circuit 265, and an infrared light-emitting diode 266.

The infrared light-emitting diode 266 is a light-emitting element and irradiates the user's eyeball making eye contact on the eyepiece unit 116 with infrared rays. The infrared rays emitted from the infrared light-emitting diode 266 are reflected at the eyeball, and the reflected infrared rays reach the dichroic mirror 262. The dichroic mirror 262 reflects only the infrared rays and transmits visible light. The reflected infrared rays changed in the optical path form an image on the imaging surface of the line of sight detection sensor 264 via the imaging lens 263. The imaging lens 263 is an optical member constituting a line of sight detection optical system. The line of sight detection sensor 264 includes an imaging device such as a CCD image sensor. The line of sight detection sensor 264 photoelectrically converts the reflected infrared rays incident thereon into an electrical signal and outputs the electrical signal to the line of sight detection circuit 265. The line of sight detection circuit 265 includes at least one processor. Based on the output signal of the line of sight detection sensor 264, the line of sight detection circuit 265 detects the user's line of sight position from the image or movement of the user's eyeball, and outputs the detected information to the system control unit 50.

In the present embodiment, the line of sight is detected by a method called corneal reflection method, using the line of sight detection block 260. The corncal reflection method is a method for detecting the direction and position of the line of sight from a positional relationship between reflected light that is the infrared rays emitted from the infrared light-emitting diode 266 and reflected at the eyeball, or the cornea in particular, and the pupil of the eyeball. There are various other methods for detecting the direction and position of the line of sight, including a method called scleral reflection that uses a difference in light reflectance between the iris and the white part of the eye. Methods of other line of sight detection units than the foregoing may be used as long as the direction and position of the line of sight can be detected. In the present embodiment, the light projection part and the light receiving part of the eye detection unit 118 are described to be devices separate from the foregoing infrared light-emitting diode 266 and the line of sight detection sensor 264. However, this is not restrictive. The infrared light-emitting diode 266 may serve as the light projection part of the eye detection unit 118, and the line of sight detection sensor 264 may serve as the light receiving part.

Based on the output from the line of sight detection block 260, the system control unit 50 can detect the following operations or states:
the line of sight of the user making eye contact on the eyepiece unit 116 is newly input (detected), which is in other words, a start of a line of sight input,
a state where there is a line of sight input of the user making eye contact on the eyepiece unit 116,
a state where the user making eye contact on the eyepiece unit 116 is fixing their gaze,
the user making eye contact on the eyepiece unit 116 moves off the line of sight that has been input, which is in other words, an end of a line of sight input, and
a state where there is no line of sight input of the user making eye contact on the eyepiece unit 116.

As employed herein, a gaze means that the user continues looking at substantially the same position for a certain period of time. As for the determination about whether the user is gazing, for example, it is determined that the user has been gazing in a case where the moving amount of the user's line of sight position does not exceed a predetermined level for a predetermined time (for example, 0.5 sec or so). The predetermined time may be able to be set by the user, or a fixed time determined in advance. The predetermined time may vary depending on a relationship in distance between the previous line of sight position and the current line of sight position. For example, the system control unit 50 determines that the user has been gazing when the duration of the state where the user's line of sight is detected at substantially the same position (no line of sight movement state) based on the detected information received from the line of sight detection circuit 265 exceeds a predetermined time (threshold period). In a case where, for example, an average detection position of the line of sight within a short period (≤the foregoing threshold period) including the latest detection timing falls within a predetermined range and the variation (dispersion) is less than a predetermined value, the system control unit 50 determines that the state is in a line of sight motionless state.

### Example of Configuration of Lens Unit 300

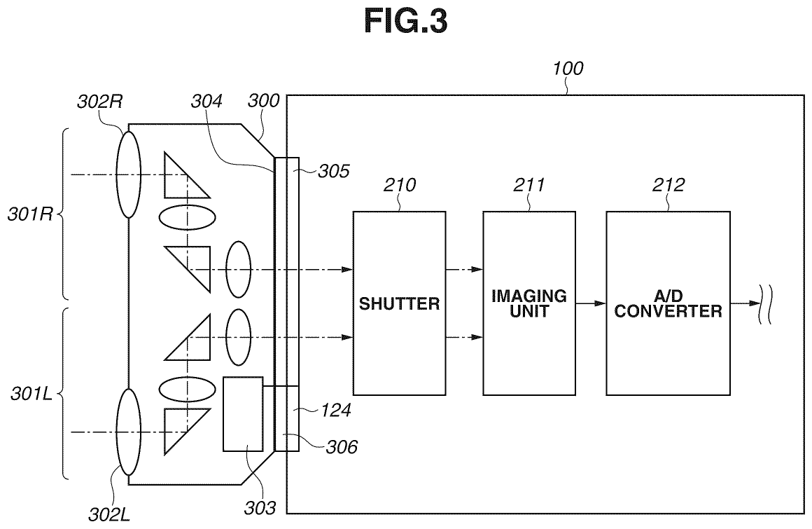

FIG. 3 is a schematic diagram illustrating an example of a configuration of a lens unit 300. FIG. 3 illustrates a state where the lens unit 300 is mounted on the camera 100. In the camera 100 illustrated in FIG. 3, components similar to those described with reference to FIG. 2 are denoted by the same reference numerals. A description thereof will be omitted as appropriate.

The lens unit 300 is a type of interchangeable lens detachably attachable to the camera 100. The lens unit 300 is a double-lens unit that can capture a left image and a right image that have a parallax relative to each other. The lens unit 300 includes two optical systems, each of which has a wide field of view angle of substantially 180° and can capture an image of a hemispherical range in front. Specifically, the two optical systems of the lens unit 300 can each capture an image of an object in a field of view (angle of view) of 180° in a lateral direction (horizontal angle, azimuth angle, or yaw angle) and 180° in a vertical direction (vertical angle, elevation angle, or pitch angle).

The lens unit 300 includes a right-eye optical system 301R including a plurality of lenses and reflection mirrors, a left-eye optical system 301L including a plurality of lenses and reflection mirrors, and a lens system control circuit 303. The right-eye optical system 301R corresponds to an example of a first optical system. The left-eye optical system 301L corresponds to an example of a second optical system. Lenses 302R and 302L located at the object side of the respective right- and left-eye optical systems 301R and 301L are directed in the same direction, with their optical axes substantially in parallel. The lens unit 300 according to the present embodiment is a virtual reality (VR) 180 (VR180) lens for capturing images for VR180, which is a format for VR images that enable a binocular stereoscopic view. The VR180 lens includes fisheye lenses through which the right- and left-eye optical systems 301R and 301L can capture respective ranges of substantially 180°. The VR180 lens may be any lens through which the right- and left-eye optical systems 301R and 301L can capture respective video images capable of binocular VR display as VR180, and may be one that can capture ranges with a wide field of view angle of around 160° narrower than the 180° ranges. The VR180 lens can form, on one or two image sensors of the camera on which the lens is mounted, a right image (first image) that is formed through the right-eye optical system 301R, and a left image (second image) that is formed through the left-eye optical system 301L and has a parallax relative to the right image.

The lens unit 300 is mounted on the camera 100 via a lens mount unit 304 and a camera mount unit 305 of the camera 100. With the lens unit 300 mounted on the camera 100, the system control unit 50 of the camera 100 and the lens system control circuit 303 of the lens unit 300 are electrically connected via the communication terminal 124 of the camera 100 and a communication terminal 306 of the lens unit 300.

In the present embodiment, the right image formed through the right-eye optical system 301R and the left image formed through the left-eye optical system 301L, which has a parallax relative to the right image, are formed on the imaging unit 211 of the camera 100 side by side. In other words, the two optical images formed by the right- and left-eye optical systems 301R and 301L are formed on a single image sensor. The imaging unit 211 converts the formed optical images (light signal) into an analog electrical signal. Using the lens unit 300, an image set including two images with a parallax can be acquired from two locations (optical systems) that are the right- and left-eye optical systems 301R and 301L. The acquired image can be divided into a left-eye image and a right-eye image and displayed by VR display, whereby the user can view a stereoscopic VR image of a substantially 180° range, i.e., VR180.

### Description of VR Image

As employed herein, VR images refer to images capable of VR display to be described below. VR images include omnidirectional images (spherical images) captured by omnidirectional cameras (spherical cameras) and panoramic images having a video range (effective video range) wider than a display range that a display unit can display at a time. VR images are not limited to still images and also include moving images and LV images (images captured by a camera substantially in real time). A VR image has a video range (effective video range) that covers a field of view of up to 360° in the lateral direction and 360° in the vertical direction. VR images include images that have an angle of view of less than 360° in the lateral direction and less than 360° in the horizontal direction but wider than that which can be captured by a normal camera, or a video range wider than a display range that a display unit can display at a time. The image captured by the camera 100 using the foregoing lens unit 300 is a type of VR image. VR images can be displayed by VR display by setting the display mode of the information processing apparatus (information processing apparatus capable of displaying VR images) to a “VR view”, for example. The user can view a laterally seamless omnidirectional video image by displaying a VR image having an angle of view of 360° by VR display and changing the orientation of the information processing apparatus in the lateral direction (horizontal direction of rotation).

As employed herein, VR display (VR view) refers to a display method (display mode) capable of changing a display range of a VR image where a video image in the field of view range corresponding to the orientation of the information processing apparatus is displayed. Among examples of VR display is “monocular VR display (monocular VR view)” where a single image is displayed through transformation of mapping a VR image onto a virtual sphere (transformation including distortion correction). Another example of VR display is “binocular VR display (binocular VR view)” where images are displayed in left and right areas side by side through transformation of mapping a left-eye VR image and a right-eye VR image onto respective virtual spheres. “Binocular VR display” using a left-eye VR image and a right-eye VR image having a parallax relative to each other enables a stereoscopic view. In either VR display, when, for example, the user wears an information processing apparatus such as a head-mounted display (HMD), a video image in the field of view range corresponding to the direction of the user's face is displayed. Suppose, for example, a video image of a VR image within a field of view range centered at 0° in the lateral direction (specific azimuth, such as the north) and 90° in the vertical direction (90° from the zenith, i.e., horizontal) is displayed at a certain point in time. In a case where the orientation of the information processing apparatus in such a state is reversed front-to-back (for example, the display plane is turned from southward to northward), the display range is changed to a video image of the same VR image within the field of view range centered at 180° in the lateral direction (opposite azimuth, such as the south) and 90° in the vertical direction. In other words, when the user wearing the HMD turns their face from the north to the south (i.e., turns back), the video image displayed on the HMD is also charged from a northward video image to a southward video image. The VR image captured using the lens unit 300 according to the present embodiment is a VR180 image where the range of substantially 180° in front is captured, and there is no video image in the range of substantially 180° behind. In a case where such a VR180 image is displayed by VR display and the orientation of the information processing apparatus is changed to the side where there is no video image, a blank area is displayed.

With such VR display of a VR image, the user experiences a visual sensation as if they are inside the VR image (VR space). The method for displaying the VR image is not limited to that which includes changing the orientation of the information processing apparatus. For example, the display range may be moved (scrolled) based on user operation via a touchscreen or directional buttons. During VR display (in the display mode “VR view”), the display range may be changed based on a touch-move on a touchscreen, a mouse drag operation, or the pressing of directional buttons in addition to the change in orientation. A smartphone mounted on VR goggles (head-mounted adaptor) is a type of HMD.

In the present embodiment, the camera 100 can display one of the left- and right-eye VR images by monocular VR display both during LV display in the imaging mode and during playback display of the captured image in the playback mode. VR display and non-VR display can be switched by pressing the directional keypad 110 upward. As employed herein, non-VR display refers to simply displaying the left and right VR images acquired by the left- and right-eye optical system 301L and 301R, respectively, without mapping transformation onto a virtual sphere like VR display. VR display during LV display in the imaging mode will hereinafter be referred to as VRLV, and non-VR display during LV display in the imaging mode as normal LV. VR display during playback display in the playback mode will hereinafter be referred to as VR playback, and non-VR display during playback display in the playback mode as normal playback.

### Transitions of VR Image Display Method During Imaging and During Playback

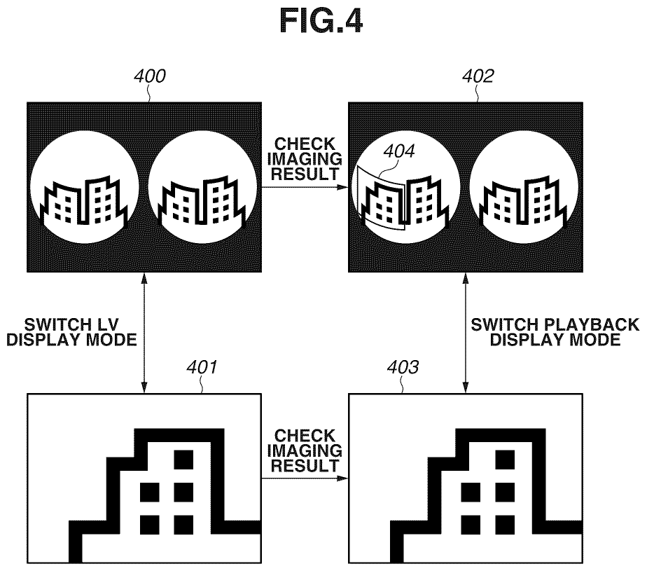

FIG. 4 is a diagram illustrating transitions of the VR image display method during imaging and during playback. Normal LV display 400 displays the object for LV display during imaging, using a non-VR display method. In the normal LV display 400, the left-eye image and the right-eye image are displayed by a circular fisheye method. More specifically, the circular image area of the left-eye image and the circular image area of the right-eye image are displayed. VRLV display 401 displays the object for LV display during imaging, using a VR display method. The VRLV display 401 displays a perspective projection image obtained by mapping one of the left- and right-eye VR images onto a virtual sphere and projecting the mapped image upon a virtual plane through perspective projection transformation. The VRLV display 401 stereoscopically displays a part of the imaging range of the VR image. In the normal LV display 400, the images are distorted. In the VRLV display 401, the distortion is reduce compared to the normal LV display 400. The VR image display methods during imaging and during playback may include a plurality of display methods including at least one of the circular fisheye method, the perspective projection method, and an equirectangular projection method.

Here, the user of the camera 100 can switch which of the left- and right-eye VR images to perform the perspective projection transformation on, by pressing the directional keypad 110 downward. The user can further move the center position of the display range by making a slide operation on the touchscreen 109, and change the magnification of the display range by making pinch-in and pinch-out operations. The display method can be switched between the normal LV display 400 and the VRLV display 401 by pressing the directional keypad 110 upward.

When the user presses the shutter button 101, the camera 100 performs various types of image processing for imaging, and when recording preparations for the recording medium 227 are completed, performs playback processing for presenting the recorded image (recorded captured image) to the user as an imaging result. Normal playback display 402 is a display method during playback to be used when imaging is performed during the normal LD display 400.

The normal playback display 402 is a non-VR display method and similar to the normal LV display 400 in appearance. The normal LV display 400 displays the circular image area of the left-eye image and the circular image area of the right-eye image. VR playback display 403 is a playback display method for providing display when imaging is performed during display by the VRLV display 401. The VR playback display 403 is a VR display method and similar to the VRLV display 401 in appearance. Specifically, in the normal playback display 402, the images are distorted. In the VR playback display 403, the distortion is reduce compared to the normal playback display 402. Here, the display range of the VR playback display 403 in the initial state and which of the left- and right-eye VR images to display are inherited from those of the VRLV display 401 when the imaging instructions are issued by the user of the camera 100. During playback, like during imaging, the display method can also be switched between the normal playback display 402 and the VR playback display 403 by pressing the directional keypad 110 upward. Like during imaging, the left- and right-eye VR images can be switched by pressing the directional keypad 110 downward. Like during imaging, the center position of the display range and the magnification can be changed by making a slide operation, pinch-in operation, and pinch-out operation on the touchscreen 109. Moreover, the initial display range of the VR playback display 403, i.e., the display range of the VRLV display 401 when the imaging instructions are issued by the user of the camera 100 can be restored by pressing the set button 111 here. A VR playback display range 404 is a frame-shaped display object (display item) indicating where the range displayed by the immediately previous VR playback display 403 is located in the normal playback display 402 when the VR playback display 403 is switched to the normal playback display 402. While in the present embodiment the VR playback display range 404 is described to be a frame-like display object, the display object may have any shape or color, like a circle, a point, or a rectangle. Any display that can indicate the display range during VR playback may be employed.

### Flowchart of Imaging Processing

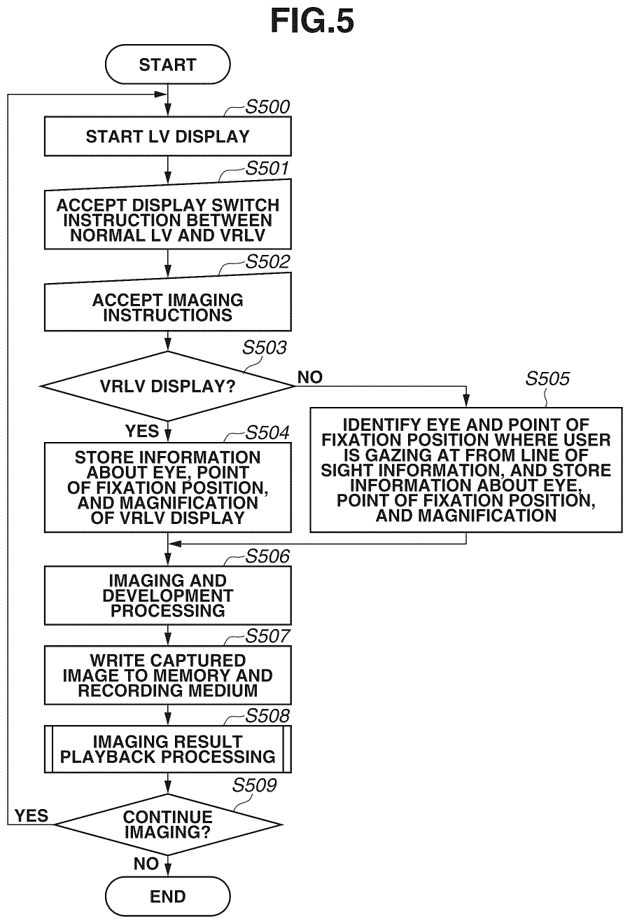

FIG. 5 is a flowchart of the imaging processing of the camera 100 according to the present embodiment. In step S500, the system control unit 50 initially starts LV display. The method for providing the LV display here is the normal LV display 400. The previous display method may be stored in the nonvolatile memory 219, and the same display method may be used in providing LV display next time.

In step S501, the system control unit 50 accepts a display switch instruction between normal LV and VRLV from the user. In other words, the system control unit 50 performs instruction acquisition to acquire an instruction to change the display method from the user. The system control unit 50 switches between the normal LV display 400 and the VRLV display 401 each time the user presses the directional keypad 110 upward.

In step S502, the system control unit 50 accepts imaging instructions from the user. The system control unit 50 detects the pressing of the shutter button 101 by the user, and enters imaging processing.

In step S503, the system control unit 50 determines whether VRLV is displayed at the time of imaging. In a case where VRLV is not displayed (NO in step S503), the processing proceeds to step S505. In step S505, the system control unit 50 identifies the eye and a point of fixation position where the user is gazing during imaging based on the line of sight information, and stores the eye and the point of fixation position. The line of sight information is that detected by the line of sight detection block 260. Which of the left- and right-eye VR images is gazed at is identified depending on which of the left and right halves of the normal LV display 400 is looked at during imaging. After the eye is identified, which part of that half is gazed at is stored in the memory 215 in the form of XY coordinates with the top left as the point of origin. For the magnification, a predetermined initial value shall be stored into the memory 215. In the present embodiment, the line of sight detection block 260 includes the EVF 217. In a case where the normal LV display 400 is displayed on other than the EVF 217, the system control unit 50 also stores predetermined initial values into the memory 215 as for the gazing eye and the point of fixation position. Alternatively, the camera 100 may include a mechanism for detecting the line of sight independent of the EVF 217, in which case the system control unit 50 performs processing similar to the processing in this step S505 in situations where the line of sight can be detected. On the other hand, in a case where VRLV is displayed (YES in step S503), the processing proceeds to step S504. In step S504, the system control unit 50 stores information about the eye, point of fixation, and magnification of the VRLV display in the memory 215.

In step S506, the system control unit 50 performs imaging and development processing.

The analog signal of the object image formed on the imaging unit 211 is thereby converted into a digital signal, and predetermined image processing is performed thereon.

In step S507, the system control unit 50 writes the captured image to the memory 215 and the recording medium 227 as the result of the imaging and development processing in the preceding step. In other words, the system control unit 50 records the captured image in a recording unit. The system control unit 50 may record information about the display method of the LV image in association with the captured image.

In step S508, the system control unit 50 performs imaging result playback processing. The purpose is to check the imaging result immediately after imaging, and the imaging result is automatically displayed without user operation. This imaging result playback processing is not necessarily limited to automatically displaying the imaging result after recording, and also applies to situations where the user deliberately issues playback instructions after imaging. Details of this imaging result playback processing will be described below.

In step S509, the system control unit 50 determines whether to continue imaging. For example, in a case where the user operates the power switch 102 to power off the camera 100, or in a case where the user presses the playback button 114 or the menu button 115 to activate other functions, the imaging is ended. On the other hand, in a case where the user presses the set button 111, the imaging is continued. In a case where the system control unit 50 determines to not continue imaging (NO in step S509), the imaging processing simply ends. On the other hand, in a case where the system control unit 50 determines to continue imaging (YES in step S509), the processing returns to step S500, and the system control unit 50 provides the LV display again.

### Flowchart of Playback Processing

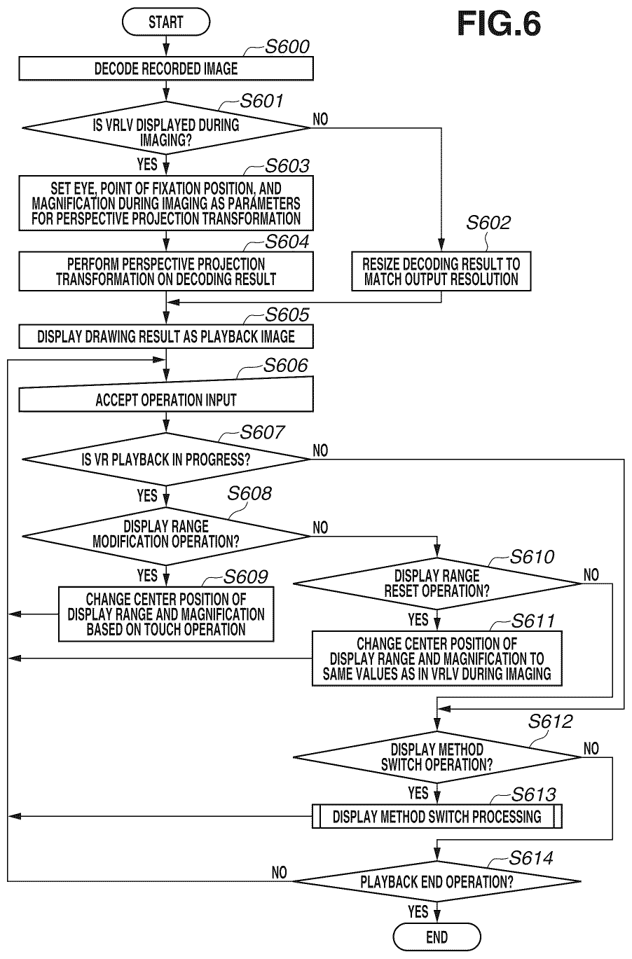

FIG. 6 is a flowchart of playback processing of the camera 100 according to the present embodiment. In step S600, the system control unit 50 decodes the recorded image. The decoding is performed using the circuitry of the image processing unit 214, whereby the content encoded in a Joint Photographic Experts Group (JPEG) format or the like is decoded and loaded into the memory 215 in a predetermined format such as a YUV format. The decoding result is one before the conversion processing for VR display is performed on the recording image, and includes a left-eye VR image and a right-eye VR image arranged side by side.

In step S601, the system control unit 50 determines whether VRLV is displayed during imaging. In a case where the information about the display method of the LV image is recorded in the recording unit in association with the captured image, the system control unit 50 determines whether VRLV is displayed during imaging based on the information recorded in the recording unit. In a case where VRLV is not displayed (NO in step S601), the processing proceeds to step S602. On the other hand, in a case where VRLV is displayed during imaging (YES in step S601), the processing proceeds to step S603.

In step S602, the system control unit 50 resizes the decoding result to match the output resolution. This resizing is intended to change the vertical and horizontal sizes of the decoding result to match the resolution of the display device such as the display unit 108 and the EVF 217.

In step S603, the system control unit 50 sets the eye, the point of fixation position, and the magnification during imaging as parameters for perspective projection transformation.

In step S604, the system control unit 50 performs perspective projection transformation on the decoded image based on the parameters set in the preceding step. A stereoscopic VR image for one eye is thereby drawn at the same point of fixation position and magnification as during imaging.

In step S605, the system control unit 50 displays the drawing result of step S602 or S604 as a playback image on the display unit 108 or the EVF 217.

In step S606, the system control unit 50 accepts operation input from the user. In a case where the user makes operation in the meantime, the content of the operation is determined and corresponding processing is performed in the subsequent processing.

In a case where operation input is accepted from the user, then in step S607, the system control unit 50 determines whether VR playback is in progress. In a case where VR playback is not in progress (NO in step S607), the processing proceeds to step S612. On the other hand, in a case where VR processing is in progress (YES in step S607), the processing proceeds to step S608.

In step S608, the system control unit 50 determines whether the user's operation input is an operation for modifying the display range (display range modification operation). Here, the system control unit 50 makes the determination based on whether the operation input is any of a slide operation, a pinch-in operation, and a pinch-out operation on the touchscreen 109. In a case where the operation input is a display range modification operation (YES in step S608), the processing proceeds to step S609. On the other hand, in a case where the operation input is not a display range modification operation (NO in step S608), the processing proceeds to step S610.

In step S609, the system control unit 50 changes the center position of the display range and the magnification based on the touch operation and performs perspective projection transformation again to modify the content of the VR display.

The processing then returns to step S606, and the system control unit 50 accepts operation input from the user again.

In step S610, the system control unit 50 determines whether the operation input is a display range reset operation. The system control unit 50 makes the determination based on whether the set button 111 is pressed by the user. In a case where the operation input is a display range reset operation (YES in step S610), the processing proceeds to step S611. In step S611, the system control unit 50 changes the center position of the display range and the magnification to the same values as in the VRLV display during imaging. For that purpose, the system control unit 50 reads the values during VRLV stored in the memory 215 and performs perspective projection transformation again. The processing then returns to step S606, and the system control unit 50 accepts operation input from the user again. On the other hand, in a case where the operation input is not a display range reset operation (NO in step S610), the processing proceeds to step S612.

In step S612, the system control unit 50 determines whether the user's operation input is a display method switch operation. The system control unit 50 makes the determination based on whether the user presses the directional keypad 110 upward. If the operation input is a display method switch operation (YES in step S612), the processing proceeds to step S613. In step S613, the system control unit 50 performs display method switch processing. Details of this processing will be described below. After the completion of the display method switch processing, the processing proceeds to step S606, and the system control unit 50 accepts operation input from the user again. On the other hand, in a case where the operation input is not a display method switch operation (NO in step S612), the processing proceeds to step S614.

In step S614, the system control unit 50 determines whether the user's operation input is a playback end operation. For example, the system control unit 50 makes the determination based on whether a predetermined key for ending the playback function, such as the playback button 114, the menu button 115, and the shutter button 101, is pressed. In a case where the operation input is not a playback end operation (NO in step S614), the processing returns to step S606, and the system control unit 50 accepts operation input from the user again. On the other hand, in a case where the operation input is a playback end operation (YES in step S614), the playback processing simply ends.

### Flowchart of Display Method Switch Processing

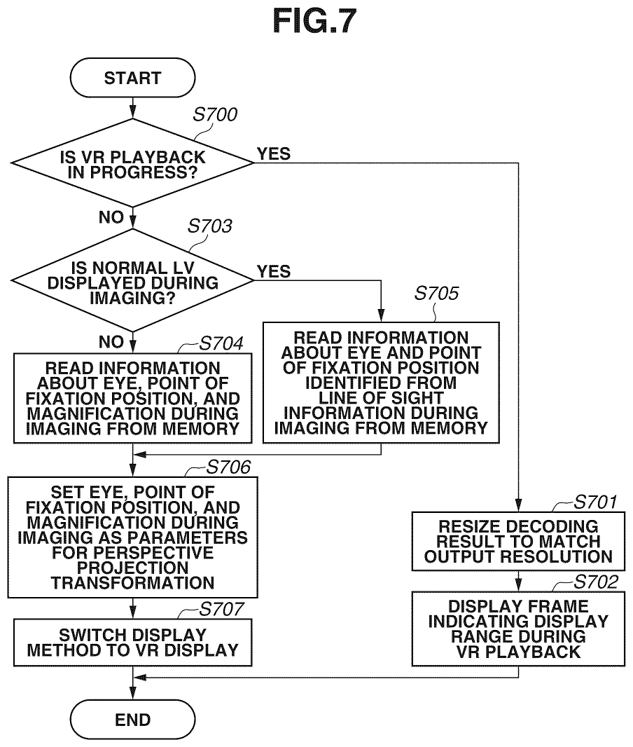

FIG. 7 is a flowchart of the display method switch processing of the camera 100 according to the present embodiment. In step S700, the system control unit 50 initially determines whether VR playback is in progress. In a case where VR playback is in progress (YES in step S700), the processing proceeds to step S701. In step S701, to switch from VR playback to normal playback, the system control unit 50 resizes the decoding result to match the output resolution. Like step S602, this resizing is intended to present the decoding result to the user with the image size changed to match the resolution of the display unit 108 or the EVF 217.

In step S702, the system control unit 50 displays the frame indicating the display range during VR playback. In this processing, the VR playback display range 404 is superimposed on the normal playback display 402. The frame is drawn with the display position and size modified based on the point of fixation position and magnification for perspective projection transformation that are last set during VR playback. On the other hand, in a case where VR playback is not in progress (NO in step S700), the processing proceeds to step S703. In step S703, the system control unit 50 determines whether normal LV is displayed during imaging. In a case where normal LV is not displayed during imaging (NO in step S703), the processing proceeds to step S704. In step S704, the system control unit 50 reads the information about the eye, the point of fixation position, and the magnification in the VRLV display during imaging from the memory 215. This information is stored in step S504. On the other hand, in a case where normal LV is displayed during imaging (YES in step S703), the processing proceeds to step S705. In step S705, the system control unit 50 reads the eye and the point of fixation position identified from the line of sight information during imaging from the memory 215. Since information about the magnification is unable to be identified from the line of sight information, the predetermined initial value stored in the memory 215 in step S505 is employed here.

In step S706, the system control unit 50 sets the eye, the point of fixation position, and the magnification read in the preceding step S704 or S705 as parameters for perspective projection transformation.

In step S707, the system control unit 50 switches the display method to VR display by performing drawing with perspective projection transformation based on the parameters set in the preceding step S706.

According to the first embodiment of the present disclosure described above, the imaging result of the VR image can be checked using a display method corresponding to a display method of the VR image during imaging.

### Modifications

(A) In the first embodiment of the present disclosure described above, the display method during playback is described to be determined based on which is displayed during imaging, normal LV or VRLV. As a modification, the camera 100 may be configured so that the user can set a desired display method for playback in advance, for example. To implement this, in step S601 illustrated in FIG. 6, the camera 100 reads the setting value of the display method during playback, stored in the nonvolatile memory 219. In a case where the setting value is VR playback, the processing proceeds to step S603. In a case where the setting value is normal playback, the processing proceeds to step S602.
(B) The present disclosure may also be an information processing method comprising the steps of each process performed by the information processing apparatus described above. Furthermore, the present disclosure may be an information processing program that causes each process performed by the information processing apparatus described above to operate on a computer. This program can be distributed via various storage media and networks, and can be executed by being installed on a computer having a storage device such as ROM.

In this case, the program and the storage medium storing the program constitute the present disclosure.

### Other Embodiments

The present disclosure can also be realized by executing the following processes. That is, software (program) that implements the functions of the above-described embodiments is supplied to a system or apparatus via a network or various storage media, and the computer (or control unit, MPU, etc.) of the system or apparatus reads and executes the program code. In this case, the program and the storage medium storing the program are included in the present disclosure.

While the present disclosure has been described in detail based on its desirable embodiments, it is not limited to these specific embodiments, and various modifications that do not depart from the gist of the disclosure are also included in the present disclosure. Portions of the above-described embodiments may be combined as appropriate.

The functional units of the above-described embodiments and modifications may be implemented as individual hardware components or not. The functions of two or more functional units may be realized by common hardware. Each of the plurality of functions of a single functional unit may be realized by individual hardware. Two or more functions of a single functional unit may be realized by common hardware. Additionally, each functional unit may be implemented by hardware such as Application-Specific Integrated Circuit (ASIC), Field-Programmable Gate Array (FPGA), Digital Signal Processor (DSP), or not. For example, the apparatus may include a processor and a memory (storage medium) storing a control program. The functions of at least some of the functional units of the apparatus may be realized by the processor reading and executing the control program from the memory.

The present disclosure can also be realized by supplying a program that implements one or more functions of the above-described embodiments to a system or apparatus via a network or storage medium, and having one or more processors of the computer in the system or apparatus read and execute the program. Additionally, it can also be realized by a circuit (e.g., ASIC) that implements one or more functions.

Furthermore, in each of the examples described above, the term “processor” refers to a broad range of processors, including general-purpose processors, e.g., CPU, and specialized processors, e.g., Graphics Processing Unit (GPU), ASIC, FPGA, and programmable logic devices, etc.

According to an embodiment of the present disclosure, the user can check the capturing result of a VR image using a display method corresponding to a display method of the VR image during imaging.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2024-119166, filed Jul. 24, 2024, which is hereby incorporated by reference herein in its entirety.

What is claimed is:

1. An information processing apparatus comprising:
a processor; and
a memory storing a program which, when executed by the processor, causes the information processing apparatus to:
execute determination processing to determine a display method to be used in displaying a live-view image on a display unit by causing a user to perform selection from among a plurality of display methods including a distortion-reduce display method; and
execute control processing to perform control to display the live-view image on the display unit, and in a case where an imaging instruction is issued while the live-view image is displayed on the display unit, control to display a captured image recorded in a recording unit on the display unit based on the imaging instruction,
wherein in a case where a first display method is selected by the user, the live-view image and the captured image are displayed on the display unit by using the first display method, and in a case where a second display method is selected by the user, the live-view image and the captured image are displayed on the display unit by using the second display method.

2. The information processing apparatus according to claim 1
wherein the program further causes the information processing apparatus to execute acquisition processing to acquire an image set including a first image and a second image having a parallax relative to each other,
wherein the plurality of display methods includes at least a third display method for displaying a predetermined area of one of the images in the image set using the distortion-reduce display method, and a fourth display method for displaying the image set.

3. The information processing apparatus according to claim 2, wherein the control processing performs, in a case where displaying of the live-view image or the captured image is switched from the third display method to the fourth display method, control to display an item indicating the predetermined area on at least the first image by using the fourth display method.

4. The information processing apparatus according to claim 2, wherein the control processing performs, in a case where the fourth display method is switched to the third display method when the user views the first image of the image set using the fourth display method, control to display the first image on the display unit by using the third display method.

5. The information processing apparatus according to claim 2, wherein the control processing performs, in a case where the fourth display method is switched to the third display method when the user views a predetermined position of the first image of the image set using the fourth display method, control to display the predetermined area including the predetermined position of the first image on the display unit by using the third display method.

6. The information processing apparatus according to claim 2, wherein the first and second images have a distorted circular image area.

7. The information processing apparatus according to claim 2,
wherein a third image is generated by the first and second images being formed on a single image sensor, and
wherein the control processing performs, in a case where the live-view image or the captured image is displayed on the display unit by using the third display method, cropping the predetermined area of the first image from the third image, transforming the cropped predetermined area into a distortion-reduce image, and control to display the distortion-reduce image on the display unit.

8. The information processing apparatus according to claim 1, wherein the control processing performs, in a case where a display method to be used in displaying the captured image has been selected by the user in advance, control to display the captured image on the display unit using the display method selected by the user in advance regardless of the display method of the live-view image.

9. The information processing apparatus according to claim 1, wherein the control processing performs control to display a predetermined area in an imaging range on the display unit as the live-view image, and in a case where the imaging instruction is issued while the predetermined area is displayed on the display unit, control to display the predetermined area of the captured image recorded in the recording unit on the display unit based on the imaging instruction.

10. The information processing apparatus according to claim 1, wherein the program further causes the information processing apparatus to execute instruction acquisition processing to acquire an instruction to switch the display methods from the user while the live-view image or the captured image is displayed on the display unit.

11. The information processing apparatus according to claim 1, wherein the program further causes the information processing apparatus to execute recording processing to record the captured image and the display method by which the live-view image has been displayed into the recording unit in association with each other, based on the imaging instruction.

12. The information processing apparatus according to claim 1, wherein the control processing performs control to display the captured image recorded in the recording unit based on the imaging instruction on the display unit, instead of the live-view image.

13. The information processing apparatus according to claim 1, wherein the plurality of display methods includes at least one of a circular fisheye method, a perspective projection method, and an equirectangular projection method.

14. The information processing apparatus according to claim 1,
wherein the program further causes the information processing apparatus to execute acquisition processing configured to acquire an instruction to display a first captured image recorded in the recording unit based on an imaging instruction issued while the live-view image has been displayed on the display unit,
wherein the control processing performs, in a case where the instruction is acquired by the acquisition processing, control to display the first captured image on the display unit.

15. A control method of an information processing apparatus comprising:
determining a display method to be used in displaying a live-view image on a display unit by causing a user to perform selection from among a plurality of display methods including a distortion-reduce display method; and
performing control to display the live-view image on the display unit, and in a case where an imaging instruction is issued while the live-view image is displayed on the display unit, control to display a captured image recorded in a recording unit on the display unit based on the imaging instruction,
wherein in a case where a first display method is selected by the user, the live-view image and the captured image are displayed on the display unit by using the first display method, and in a case where a second display method is selected by the user, the live-view image and the captured image are displayed on the display unit by using the second display method.

16. A non-transitory computer readable recording medium that stores a program, wherein the program causes a computer to execute a control method according to claim 15.

17. A system comprising:
a display apparatus;
a determination apparatus configured to determine a display method to be used in displaying a live-view image on a display apparatus by causing a user to perform selection from among a plurality of display methods including a distortion-reduce display method; and
a control apparatus configured to perform control to display the live-view image on the display apparatus, and in a case where an imaging instruction is issued while the live-view image is displayed on a display unit, control to display a captured image recorded in a recording unit on the display apparatus based on the imaging instruction,
wherein in a case where a first display method is selected by the user, the live-view image and the captured image are displayed on the display unit by using the first display method, and in a case where a second display method is selected by the user, the live-view image and the captured image are displayed on the display unit using the second display method.
